(19) United States
(12) Patent Application Publication
(10) Pub. No.: US 2007/0278972 A1
(43) Pub. Date: Dec. 6, 2007

(54) Current-limited starting type capacitive electronic ballast for fluorescent lamp

(76) Inventor: Hsien-Meng Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/447,126

(22) Filed: Jun. 6, 2006

(51) Int. Cl. H05B 41/36

(52) U.S. Cl. 315/291

(57) ABSTRACT

An electronic ballast formed of a rectifier circuit, a high-frequency voltage generator, a cross-linking circuit, a triggering circuit, a high-frequency oscillator and a choke coil is disclosed to limit the electric current upon starting of the electronic ballast so as to prevent damage to the lamp tube, and to isolate the power supply from the lamp tube before generation of a high-frequency voltage so that only the high-frequency power supply is provided to the lamp tube to prevent burning of the oscillation power transistor.

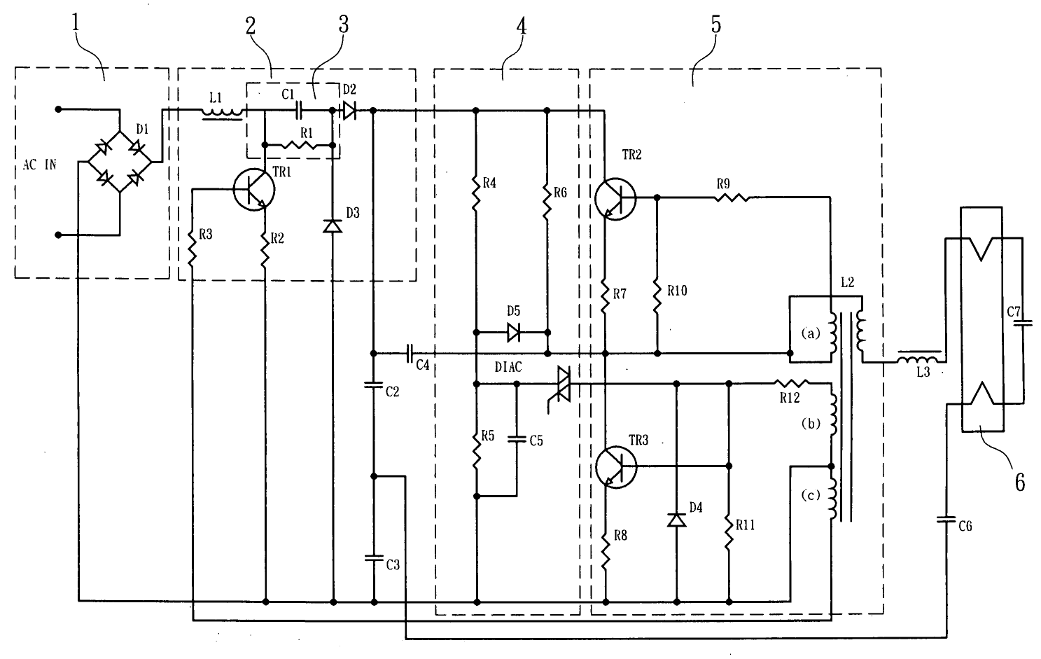

### BACKGROUND OF THE INVENTION

1. Field of the Invention

The present invention relates to a ballast for fluorescent lamp and more particularly, to a current-limited starting type capacitive electronic ballast for fluorescent lamp.

2. Description of the Related Art

When starting an electronic ballast, a surge may be produced, causing damage to the lamp tube and shorting the working life of the lamp tube. When many fluorescent lamps are used together, they cannot be started at the same time because a transient high current will be produced to cause the fuse to trip off or to burn. Further, when the ambient temperature or humility is excessively high, or the high-frequency potential is floating, or the resistant value of the lamp tube is changed, the oscillation power transistor may burn out. These drawbacks cause consumers to lose their confidence in electronic ballasts.

### SUMMARY OF THE INVENTION

The present invention has been accomplished under the circumstances in view. It is the main object of the present invention to provide an electronic ballast, which is highly reliable and safe in use. According to the present invention, the electronic ballast is comprised of high-frequency voltage generator, a cross-linking circuit, a triggering circuit, a high-frequency oscillator, and a choke coil. When starting the electronic ballast, the resistor of the cross-linking circuit limits the current, allowing the voltage to be shunted by resistors to charge a capacitor, so as to enable the capacitor to charge a triggering diode. When the triggering diode is charged to the critical voltage, it turns on a power transistor, thereby causing the high-frequency oscillator to oscillate and to further turn on the lamp tube. Further, an oscillation winding of the high-frequency oscillator simultaneously excites the high-frequency voltage generator, causing the high-frequency voltage generator to generate a high-frequency voltage, and the high-frequency voltage thus produced turns on the cross-linking circuit to provide the necessary working power to the lamp tube.

### BRIEF DESCRIPTION OF THE DRAWINGS

The FIG. is a circuit diagram of an electronic ballast according to the present invention.

### DETAILED DESCRIPTION OF THE PREFERRED EMBODIMENT

Referring to the annexed drawing of the FIG., an electronic ballast in accordance with the present invention is shown comprised of a rectifier circuit 1, a high-frequency voltage generator 2, a cross-linking circuit 3, a triggering circuit 4, a high-frequency oscillator 5, a choke coil L3, and a lamp tube 6.

The rectifier circuit 1 is a full-wave bridge rectifier formed of a rectifying diode D1 and adapted to convert AC into DC.

The high-frequency voltage generator 2 is comprised of an oscillation winding L1, a power transistor TR1, the cross-linking circuit 3, which comprises a capacitor C1 and a resistor R1 connected in parallel to the capacitor C1, two rectifying diodes D1 and D3, two filtering capacitors C2 and C3, and the triggering circuit 4, which is comprised of resistors R4, R5 and R6, a capacitor C5 and a triggering diode DIAC. When AC is rectified into DC, it passes through the resistor R1 to charge the filtering capacitors C2 and C3 with a limited current, allowing the voltage to be shunted by the resistors R4 and R5 to charge the capacitor C5, so as to enable the capacitor C5 to charge the triggering diode DIAC. When the triggering diode DIAC is charged to the critical voltage (about 30V), the triggering diode DIAC immediately triggers the power transistor TR3, thereby causing the high-frequency oscillator 5 to oscillate and to further turn on the lamp tube 6.

As indicated above, when electric power is connected, DC power passes through the resistor R1 to charge the filtering capacitors C2 and C3 with a limited current, allowing the voltage to be shunted by the resistors R4 and R5 to charge the capacitor C5, so as to enable the capacitor C5 to charge the triggering diode DIAC. When the triggering diode DIAC is charged to the critical voltage (about 30V), the triggering diode DIAC turns on the power transistor TR3, thereby causing the high-frequency oscillator 5 to oscillate and to further turn on the lamp tube 6. Further, the oscillation winding L2 of the high-frequency oscillator 5 simultaneously excites the power transistor TR1 of the high-frequency voltage generator 2, causing the oscillation winding L2 to generate high-frequency oscillation, and the voltage thus produced from the high-frequency oscillation turns on the cross-linking capacitor C1. At this time, the necessary working power of the lamp tube 6 is provided by the cross-linking capacitor C1, and therefore the lamp tube 6 keeps emitting light. Other equivalent oscillation means may be used to excite the power transistor TR1 of the high-frequency voltage generator 2.

As stated above, when starting the fluorescent lamp, electric current passes through the resistor R1, which has high resistance value. Therefore, starting the fluorescent lamp does not cause a surge. Therefore, it is safe to start the fluorescent lamp with a limited current. When started, the high-frequency oscillation winding L2 is caused to oscillate and to excite the power transistor TR1, thereby causing the high-frequency oscillation winding L1 to generate a high-frequency voltage that turns on the cross-linking capacitor C1 to provide the necessary working power to the lamp tube 6. Because the electric current of the cross-linking capacitor C1 is all obtained from the high-frequency oscillation winding L1 and limited to a predetermined level, the operation of the present invention does not cause the oscillation power transistor to burn. Therefore, the invention is safe in use.

Further, the oscillation winding L1 of the high-frequency voltage generator 2 is of “self feedback oscillation” type, it greatly improves the working efficiency of the power, achieving a power factor as high as 99% and up.

Further, the oscillation winding L1 of the high-frequency voltage generator 2 and the cross-linking capacitor C1 isolate the power supply from the lamp tube, therefore resonant distortion produced by the high-frequency oscillator 5 does not enter the power supply, preventing interference. This isolation effect also lowers the rest factor of the sine wave of the power supply relative to the lamp tube filament to 0.8 (that is lower than 1.0 of the crest factor of the lamp tube filament itself). Therefore, the invention greatly prolongs the working life of the lamp tube, eliminates resonant wave distortion, and consumes less power.

Although a particular embodiment of the invention has been described in detail for purposes of illustration, various modifications and enhancements may be made without departing from the spirit and scope of the invention.

What the invention claimed is:

1. An electronic ballast used in a fluorescent lamp for driving a lamp tube through an oscillation circuit, comprising a capacitor isolation circuit means adapted to isolate the power supply from said lamp tube and said oscillation circuit, said capacitor isolation circuit means comprising a paralleled resistor adapted to limit the electric current when the electronic ballast is started so that the power supply is provided to said lamp tube only when a high-frequency voltage is produced by a high-frequency voltage generator of the electronic ballast.

2. The heat-transfer plate member as claimed in claim 1, wherein said high-frequency voltage generator is comprised of a power transistor.
